(19) United States
(12) Patent Application Publication
(10) Pub. No.: US 2025/0156343 A1
(43) Pub. Date: May 15, 2025

(54) COMPUTING SYSTEM AND MEMORY MANAGING METHOD

(71) Applicant: MEDIATEK INC., Hsinchu City (TW)

(72) Inventors: Wei-Ting Hung, Hsinchu City (TW); Hsien-Peng Wang, Hsinchu City (TW)

(21) Appl. No.: 18/825,003

(22) Filed: Sep. 5, 2024

Related U.S. Application Data
(60) Provisional application No. 63/598,135, filed on Nov. 12, 2023.

(51) Int. Cl. G06F 13/16

(52) U.S. Cl. CPC G06F 13/1663; G06F 13/1621; G06F 13/1668

(57) ABSTRACT

A computing system, includes a memory device, which further includes a memory storage and a memory controller. The memory controller is used to utilize a plurality of registers to manage a plurality of memory spaces in the memory storage. Several of computing engines, are used to execute a plurality of computations, read a plurality of consumed data from the memory storage for processing, and write the processed data as produced data to the memory storage. The memory controller utilizes a managing table to record an identifier, a base address, a bound address, a delete size, a head pointer, a tail pointer, and two indicators of each of the registers.

This application claims the benefit of U.S. provisional application Ser. No. 63/598,135, filed Nov. 12, 2023, the disclosure of which is incorporated by reference herein in its entirety.

### TECHNICAL FIELD

The disclosure relates to a computing system, and particularly relates to a computing system with multiple computing engines and a memory managing method for the computing system.

### BACKGROUND

In the field of artificial intelligence (AI) technology, a huge amount of computations are usually required, which involve multiple computing engines dedicated to various types of computations. These computing engines may utilize dedicated memory units respectively, which is “dedicated memory” mechanism. However, in the dedicated memory mechanism, exclusive memory spaces of multiple dedicated memory units are concurrently accessed, hence requiring complex management and synchronization.

In contrast to the dedicated memory mechanism, a shared memory mechanism may be utilized, which employs a unified memory space to simplify the management and synchronization. The shared memory mechanism may encounter a data dependency issue when read operations or write operations are executed concurrently, particularly for the computing engines with different throughput.

In view of the above issue, it is desirable to have a computing system with an improved architecture, which is capable of resolving the data dependency issue in the shared memory. Furthermore, an improved memory managing method is required to manage the memory device in the above computing system.

### SUMMARY

According to one embodiment of the present disclosure, a computing system is provided. The computing system includes the following elements. A memory device includes a memory storage and a memory controller. The memory storage is used to store a plurality of data. The memory controller is used to utilize a plurality of registers to manage a plurality of memory spaces in the memory storage. Several of computing engines, are used to execute a plurality of computations, read a plurality of consumed data from the memory storage for processing, and write the processed data as produced data to the memory storage. The memory controller utilizes a managing table to record an identifier, a base address, a bound address, a delete size, a head pointer, a tail pointer, and two indicators of each of the registers.

According to another embodiment of the present disclosure, a memory managing method in a computing system is provided. The computing system includes a memory device and several computing engines. The memory managing method includes the following steps. A plurality of consumed data are stored, by a memory storage of the memory device. Several registers are utilized to manage a plurality of memory spaces in the memory storage, by a memory controller of the memory device. Several computations are executed, the consumed data are read from the memory storage for processing, and the processed data are written to the memory storage as produced data, by the computing engines. A managing table is utilized by the memory controller to record an identifier, a base address, a bound address, a delete size, a head pointer, a tail pointer, and two indicators of each of the registers.

### BRIEF DESCRIPTION OF THE DRAWINGS

FIG. 1 illustrates a block diagram of a computing system according to an embodiment of the present disclosure.

FIG. 2 illustrates a schematic diagram showing a managing table utilized by a memory controller.

FIG. 3A illustrates a schematic diagram showing an reserved memory space for a corresponding register.

FIGS. 3B and 3C illustrate schematic diagrams showing the reserved memory space and an available data for the corresponding register.

FIGS. 4A and 4B illustrate schematic diagrams showing data dependency and hazards under a read-after-write (RAW) condition.

FIGS. 4C and 4D illustrate schematic diagrams showing data dependency and hazards under write-after-read (WAR) and write-after-write (WAW) conditions.

FIG. 5 illustrates a schematic diagram showing pipelined operations by the computing engines according to an embodiment of the present disclosure.

FIG. 6 illustrates a schematic diagram showing non-pipelined operations of a comparative example.

FIG. 7 illustrates a block diagram of a computing system of another comparative example.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

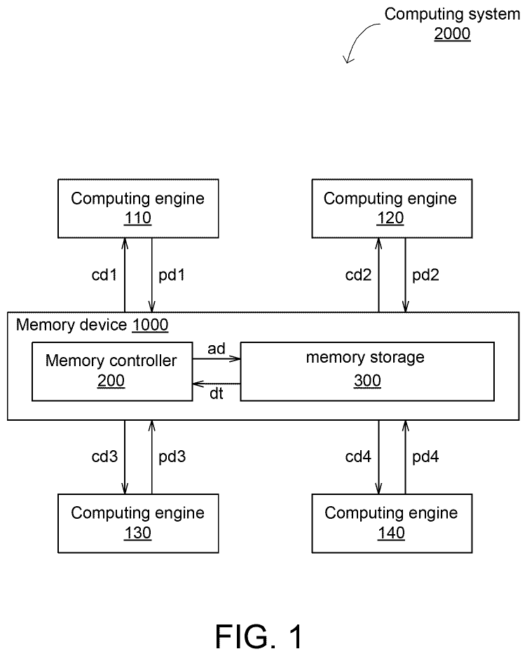

FIG. 1 illustrates a block diagram of a computing system 2000 according to an embodiment of the present disclosure. Referring to FIG. 1, the computing system 2000 includes a memory device 1000 and a plurality of computing engines, e.g., four computing engines 110 to 140. The computing system 2000 is used to perform various types of computations (e.g., vector computations, matrix computations, and three-dimensional (3D) computations, etc.), and the computing engines 110 to 140 serve as processing cores for executing these computations.

When executing computations, the computing engines 110 to 140 may read data from the memory device 1000 for processing, and write the processed data to the memory device 1000. The data read from the memory device 1000 may be referred to as “consumed data”, which means the data are consumed by the computing engines 110 to 140. On the other hand, the data written to the memory device 1000 may be referred to as “produced data”, which means the data are produced by the computing engines 110 to 140. In the example of FIG. 1, the computing engine 110 reads consumed data cd1 from the memory device 1000 and writes produced data pd1 to the memory device 1000. Likewise, the computing engines 120, 130 and 140 respectively read consumed data cd2, cd3 and cd4 from the memory device 1000 and respectively write produced data pd2, pd3 and pd4 to the memory device 1000.

When performing computations for deep learning, the computing engines 110 to 140 may execute one-dimensional (1D) operations, two-dimensional (2D) operations or the aforementioned 3D operations respectively. For example, the computing engine 110 may be configured to execute 1D operations, and the consumed data cd1 and produced data pd1 of the computing engine 110 may be associated with 1D sequential data (e.g., time series data or text data). Furthermore, the computing engine 120 may be configured to execute 2D operations (e.g., image processing including convolutional operations), and the consumed data cd2 and produced data pd2 of the computing engine 120 may be associated with 2D-image arrays. Moreover, the computing engine 130 may be configured to execute 3D operations (e.g., video processing), and the consumed data cd3 and produced data pd3 of the computing engine 130 may be associated with 3D-frame sequences. In addition, the computing engine 140 may be configured to execute load operation and store operation.

The computing engines 110 to 140 may access the produced data pd1 to pd4 and the consumed data cd1 to cd4 with the memory device 1000 in a “shared memory” mechanism. That is, the computing engines 110 to 140 are able to directly access and share the produced data pd1 to pd4 and consumed data cd1 to cd4 in a unified memory space of the memory device 1000, such that communication and coordination between the computing engines 110 to 140 and the memory device 1000 may be enhanced, also, data allocation and data deallocation in the memory device 1000 may be managed more efficiently.

The memory device 1000 includes a memory controller 200 and a memory storage 300. The memory controller 200 may communicate with the memory storage 300 through a data bus “dt” and an address bus “ad”. The memory storage 300 may be any type of volatile storage or non-volatile storage, e.g., a dynamic random access memory (DRAM), a static random access memory (SRAM), a flash memory or a cache memory, etc. Furthermore, the memory storage 300 may be a mass storage medium, e.g., an optical disc, a hard disc drive (HDD) or a solid state drive (SSD), etc.

The memory storage 300 provides a unified memory space (i.e., a “common pool”) for storing the produced data pd1 to pd4 and the consumed data cd1 to cd4. The memory controller 200 is used to control write operations of the produced data pd1 to pd4 and the read operations of the consumed data cd1 to cd4 in the unified memory space of the memory storage 300.

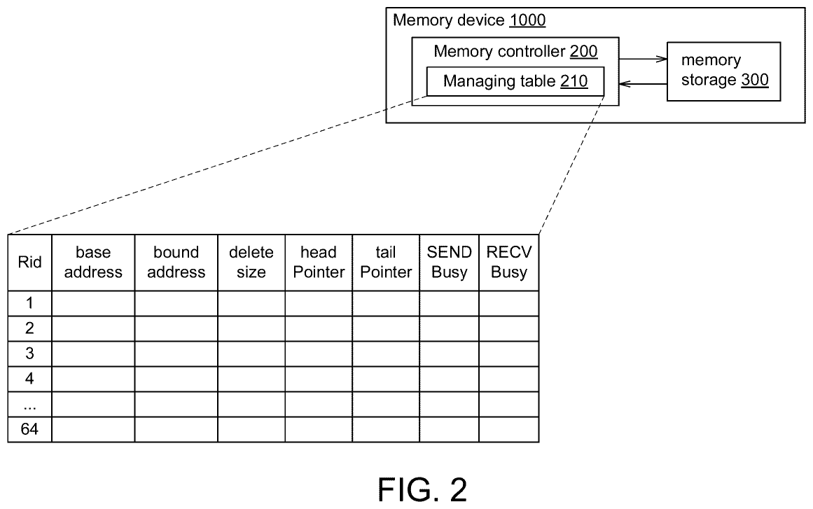

The memory controller 200 is used to control write operations and read operations for the memory storage 300. The memory controller 200 may utilize a plurality of registers (e.g., N registers) to manage memory spaces in the memory storage 300 when performing write operations and read operations. In one example, the number N is “64”, and sixty-four registers R1 to R64 are utilized by the memory controller 200. Each of the registers R1 to R64 has an identifier referred to as “Rid”. Such as, the register R1 has an identifier Rid of “1”, and the register R2 has an identifier Rid of “2”, etc. Furthermore, the memory controller 200 may utilize a managing table to manage the registers R1 to R64, as will be described in the following paragraphs with reference to FIG. 2.

FIG. 2 illustrates a schematic diagram showing a managing table 210 utilized by a memory controller 200. The memory controller 200 may have a compiler (not shown in FIG. 2) which is executed in a software level. The managing table 210 may be generated by the compiler when executing in the memory controller 200. Each of the registers R1 to R64 may have a plurality of parameters and indicators. Some parameters of the registers R1 to R64, which are recorded in the managing table 210, are maintained by the compiler, in a software level.

Furthermore, the memory controller 200 may have a L1 managing unit (not shown in FIG. 2) which is a hardware element (e.g., a lumped circuit, a micro-processor, or an ASIC chip) embedded in the memory device 1000. Some other parameters of the registers R1 to R64 in the managing table 210 are controlled (i.e., handled) by the L1 managing unit, in the hardware level.

Table 1 shows an example of the contents of the managing table 210. Referring to both FIG. 2 and Table 1, the managing table 210 may record the identifier Rid, the parameters and the indicators of the registers R1 to R64. In the first column of the managing table 210, the identifier Rid is recorded. The registers R1 to R64 are indexed by the identifiers Rid of “1” to “64”. In other columns of the managing table 210, parameters of “base address”, “bound address”, “delete size”, “head pointer” and “tail pointer” and two indicators named “SEND busy” and “RECV busy” of each of the registers R1 to R64, are recorded. That is, the memory controller 200 may utilize the managing table 210 to record the identifier “Rid”, “base address”, “bound address”, “delete size”, “head pointer”, “tail pointer”, “SEND busy” indicator and “RECV busy” indicator of each of the registers R1 to R64.

TABLE 1

| | base | bound | delete | head | tail | SEND | RECV |
|---|---|---|---|---|---|---|---|
| Rid | address | address | size | pointer | pointer | busy | busy |
| 1 | 0x00 | 0x09 | 0x10 | 0x00 | 0x09 | 1 | 1 |
| 2 | 0x10 | 0x19 | 0x10 | 0x10 | 0x19 | 1 | 1 |
| 3 | 0x20 | 0x29 | 0x10 | 0x20 | 0x29 | 1 | 1 |
| 4 | 0x30 | 0x39 | 0x10 | 0x30 | 0x39 | 1 | 1 |
| . . . | | | | | | | |
| 64 | 0x00 | 0x00 | 0x00 | 0x00 | 0x00 | 1 | 1 |

Among these parameters of the registers R1 to R64, the base address and bound address are used to define a reserved memory space in the memory storage 300 for the corresponding register. Taking the register R1 (with the identifier Rid of “1” in the managing table 210) as an example, the base address of the register R1 is “0x00”, and its bound address is “0x09”, hence a reserved memory space of 9 bytes in the memory storage 300 is defined for the register R1.

Furthermore, the delete size is used to indicate the amount of data which can be released from a corresponding register after last read operation or last write operation. Such as, the delete size of the register R1 is “0x10”, indicating that 16 bytes data can be released after last operation. Moreover, the head pointer and tail pointer are used to respectively indicate a start and an end of stored data for the corresponding register, and the stored data may be referred to as “available data” in this register. The available data defined by the head pointer and tail pointer should fall within the reserved memory space defined by the base address and the bound address. In other words, the head pointer and tail pointer should be located between the base address and bound address.

In addition, the “SEND busy” indicator is used to indicate a busy state for a read operation for a corresponding register, which indicates that a read operation for this interested register is under performing. On the other hand, the “RECV busy” indicator is used to indicate a busy state for a write operation for a corresponding register, which indicates that a write operation for this interested register is under performing. Such as, the indicators “SEND busy” and “RECV busy” of the register R1 are both “1”, indicating that both read operation and write operation are under performing for the register R1. The indicators “SEND busy” and “RECV busy” of the register R1 are used to make sure only one read operation and/or only one write operation are/is simultaneously executed for the register R1, which may prevent disordered deletion or multiple writing for the register R1.

The managing table 210 may be generated by a compiler of the memory controller 200. The complier may be executed in the memory controller 200 and generate a set of assembly codes, forming the managing table 210 based on the identifier Rid of the registers R1 to R64. In the managing table 210, the base address, bound address and delete size of each of the registers R1 to R64 are maintained (i.e., set, reset or updated) by the compiler. In one example, the base address, bound address and delete size may be updated once for the registers R1 to R64, since base address, bound address and delete size are frequently used information for the memory device 1000.

On the other hand, the head pointer, tail pointer and indicators “SEND busy” and “RECV busy” in the managing table 210 may be maintained by a L1 managing unit of the memory controller 200. That is, in the managing table 210, the base address, bound address and delete size may be maintained by the compiler at a software level, while the head pointer, tail pointer and indicators “SEND busy” and “RECV busy” may be maintained at a hardware level. When performing read operations and write operations, the compiler of the memory controller 200 needs not handle detailed actions of the head pointer, tail pointer and indicators “SEND busy” and “RECV busy”.

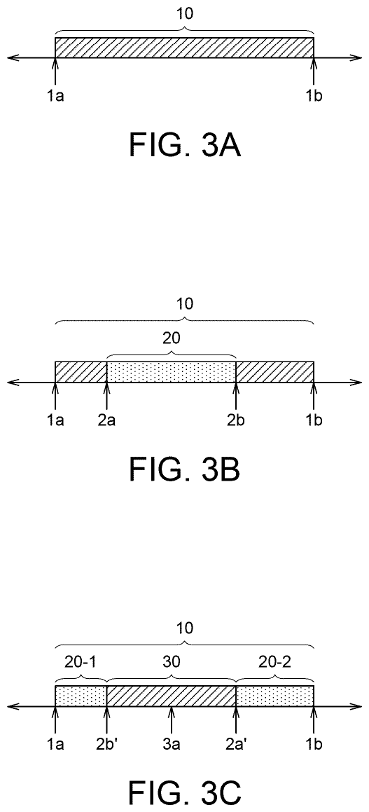

The detailed operations of the base address, bound address, head pointer and tail pointer are described in the following paragraphs by reference with FIGS. 3A to 3C. FIG. 3A illustrates a schematic diagram showing a reserved memory space for a corresponding register, and FIGS. 3B and 3C illustrate schematic diagrams showing the reserved memory space and an available data for the corresponding register. Firstly, referring to FIG. 3A, a reserved memory space 10 in the memory storage 300 for a corresponding register, may be defined by the base address 1a and the bound address 1b.

Next, referring to FIG. 3B, when one of the produced data pd1 to pd4 of corresponding one the computing engines 110 to 140 as shown in FIG. 1 is written into the corresponding register, the written data in this register forms the available data 20 within the reserved memory space 10. The start of the available data 20 is pointed by the head pointer 2a, and the end of the available data 20 is pointed by the tail pointer 2b. The head pointer 2a and the tail pointer 2b are located between the base address 1a and the bound address 1b.

The memory controller 200 may control read operations and write operations for each of the registers R1 and R64 with a first-in and first-out (FIFO) mechanism. When performing a write operation for an incoming data, the “RECV busy” indicator of a corresponding register is set as “1”. The incoming data is written into an address next to the tail pointer 2b, and the tail pointer 2b moves in response to the “RECV busy” indicator. That is, in the write operation, incoming data should be “pushed” to a tail of a FIFO of this register.

On the other hand, when performing a read operation for an outgoing data, the “SEND busy” indicator of a corresponding register is set as “1”. The outgoing data is read from an address pointed by the head pointer 2a, and the head pointer 2a moves in response to the “SEND busy” indicator. That is, in the read operation, outgoing data should be “popped” from a head of the FIFO of this register.

Next, referring to FIG. 3C, another interested register may store two sections of available data 20-1 and 20-2. Hence, a memory space (referred to as “available memory space”) between the tail pointer 2b′ of available data 20-1 and the head pointer 2a′ of available data 20-2 is available for write operation. That is, when performing write operations, a write pointer 3a is located between the tail pointer 2b′ and head pointer 2a′. An address pointed by the write pointer 3a is greater than the address pointed by the tail pointer 2b′ and less than the address pointed by the head pointer 2a′.

When read operations and write operations are performed concurrently for the computing engines 110 to 140, the memory controller 200 utilizes the managing table 210 to resolve data dependency. Logical addresses (i.e., base address and bound address, etc.) and data dependency are handled by the compiler in the software level. On the other hand, physical addresses and data dependency of the memory storage 300 are handled by the L1 managing unit of the memory controller 200. In an initial stage, the L1 managing unit of the memory controller 200 may reset the head pointer and the tail pointer to the base address, for each of the registers R1 to R64. Only one write operation associated with the “RECV busy” indicator or only one read operation associated with the “SEND busy” indicator are executed at the same time for each of the registers R1 to R64, and the head pointer and tail pointer are only used by a corresponding one of the computing engines 110 to 140.

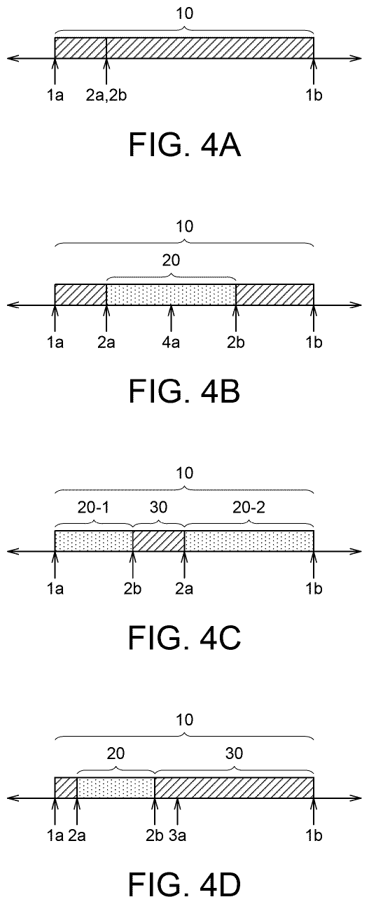

FIGS. 4A and 4B illustrate schematic diagrams showing data dependency and hazards under a read-after-write (RAW) condition. In the RAW condition, a read operation is performed after a write operation. If the size of read data (i.e., data to be read) for the read operation (referred to as “read size”) is greater than the size of available data 20 in the corresponding register, meaning that the available data 20 is not enough for the read operation. Therefore, the read operation may be stalled. In the example of FIG. 4A, the head pointer 2a and tail pointer 2b point to the same address (i.e., the head pointer 2a overlaps with the tail pointer 2b), meaning that there is no available data 20 in this register (i.e., the size available data 20 is equal to “0”). Therefore, the read operation for this register may be stalled until the available data size is larger than the read size.

Next, referring to FIG. 4B, the available data 20 between the head pointer 2a and tail pointer 2b has a size greater than the read size of the read operation, meaning that the available data 20 is enough for the read operation. Therefore, the read operation will be performed, and a read pointer 4a is located within an address range (i.e., a range between the head pointer 2a and tail pointer 2b) associated with the available data 20. The read pointer 4a may move between the head pointer 2a and tail pointer 2b to read data within the available data 20.

More particularly, for the read operations, memory controller 200 may predefine a “read-ordering” for all of the computing engines 110 to 140. With the read-ordering, the L1 managing unit of the memory controller 200 can determine which data to be read for the computing engines 110 to 140. Such as, initially, the read pointer 4a may point to an address of head pointer 2a (this address is referred to as “addr_head”). Then, read pointer 4a moves by a step of X address units. That is, read pointer 4a points to addr_head, and moves to (addr_head+X), then moves to (addr_head+2X), (addr_head+3X), . . . , (addr_head+nX). Thereafter, read pointer 4a backs to (addr_head+1), then moves to (addr_head+1+X), (addr_head+1+2X), etc.

Furthermore, when the read operation is completed, the head pointer 2a may move by a step equal to the delete size in the managing table 210. In one example, the compiler of the memory controller 200 may check an indicator named “last_use”. If the indicator “last_use” has a content of “1”, indicating that the read data by the read pointer 4a in the available data 20 will not be used by other computing engines, then the head pointer 2a may move with the delete size.

FIGS. 4C and 4D illustrate schematic diagrams showing data dependency and hazards under write-after-read (WAR) and write-after-write (WAW) conditions, in which a write operation is performed after a read operation, or a write operation is performed after a write operation. If the size of write data (i.e., data to be written) for the write operation (referred to as “write size”) is greater than the size of available memory space 30 in the corresponding register, meaning that the available memory space 30 is not enough for the write operation. Therefore, the write operation may be stalled. In the example of FIG. 4C, the available memory space 30 (which is located between the tail pointer 2b of the available data 20-1 and the head pointer 2a of the available data 20-2) has a size less than the write size of the write operation, hence the write operation for this register may be stalled until the available memory space is larger than the write size.

Next, referring to FIG. 4D, the available memory space 30 (which is located between the tail pointer 2b of the available data 20 and bound address 1b) has a size greater than the write size of the write operation, meaning that the available memory space 30 is enough for the write operation. Therefore, the write operation for this register will be performed, and a write pointer 3a may move between the tail pointer 2b and the bound address 1b. When a data is written into the memory storage 300 for this register, the tail pointer 2b moves with one address unit.

In one example, the memory controller 200 may predefine a “write-ordering” for all of the computing engines 110 to 140, such that the L1 managing unit of the memory controller 200 can determine which data to be written for the computing engines 110 to 140. The write-ordering may be similar to the read-ordering as mentioned above. Such as, the write pointer 3a may move by a step of X address units: initially pointing to “addr_tail” (i.e., an address of tail pointer 2b), and moving to (addr_tail+X), (addr_tail+2X), and (addr_tail+3X), etc. Then, the write pointer 3a backs to (addr_tail+1), and moving to (addr_tail+1+X), (addr_tail+1+2X), and (addr_tail+1+3X), etc.

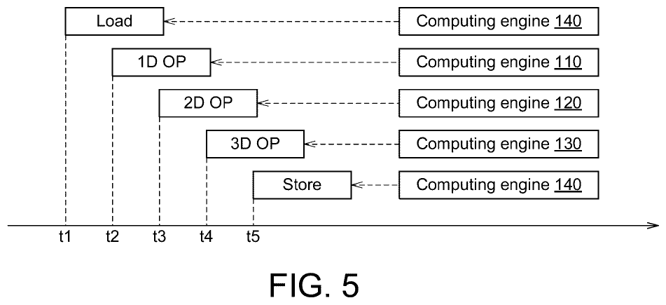

FIG. 5 illustrates a schematic diagram showing pipelined operations by the computing engines 110 to 140 according to an embodiment of the present disclosure. In the example of FIG. 5, the computing engines 110 to 140 execute operations in a pipelined manner. The computing engine 140 executes a load operation, the computing engine 110 executes a 1D operation, the computing engine 120 executes a 2D operation, and the computing engine 130 executes a 3D operation. Finally, the computing engine 140 executes a store operation.

More particularly, the load operation may be started at time point t1. In the pipelined manner, once the data needed for the 1D operation is ready, the 1D operation may be started without waiting a completion of the load operation. Such as, the 1D operation may be started at time point t2 when the needed data is ready. Then, the 2D operation may be started at time point t3 without waiting a completion of the 1D operation. Likewise, the 3D operation may be started at time point t4 without waiting a completion of the 2D operation. Then, the store operation may be started at time point t5.

The load operation, 1D operation, 2D operation, 3D operation and store operation are performed by the computing engines 110 to 140 based on the registers R1 to R4 in the managing table 210 shown as Table 2-1. Furthermore, these operations are performed according to a set of program codes listed as Table 2-2.

TABLE 2-1

| | base | bound | delete | head | tail | SEND | RECV |
|---|---|---|---|---|---|---|---|
| Rid | address | address | size | pointer | pointer | busy | busy |
| 1 | 0x00 | 0x09 | 0x10 | 0x00 | 0x09 | 1 | 1 |
| 2 | 0x10 | 0x19 | 0x10 | 0x10 | 0x19 | 1 | 1 |
| 3 | 0x20 | 0x29 | 0x10 | 0x20 | 0x29 | 1 | 1 |
| 4 | 0x30 | 0x39 | 0x10 | 0x30 | 0x39 | 1 | 1 |

TABLE 2-2

REGISTER R1 0x00~0x09
REGISTER R2 0x10~0x19
REGISTER R3 0x20~0x29
REGISTER R4 0x30~0x39
LOAD R1
1D-OP dest = R2, src = R1
2D-OP dest = R3, src = R2
3D-OP dest = R4, src = R3
STORE R4

In the set of program codes, base address of “0x00” and bound address of “0x09” is set for register R1. Then, base address of “0x10” and bound address of “0x19” is set for register R2. Likewise, base address of “0x20” and bound address of “0x29” is set for register R3, and, base address of “0x30” and bound address of “0x39” is set for register R4.

Then, load operation is performed for register R1, such that interest data is loaded to register R1. Then, 1D operation is performed with register R1 as a source and register R2 as a destination. That is, 1D operation is performed on the loaded data in register R1, and result of 1D operation is stored in register R2. Similarly, 2D operation is performed with register R2 as a source and register R3 as a destination. 3D operation is performed with register R3 as a source and register R4 as a destination. Finally, store operation is performed for register R4 to store the result of the 3D operation.

Given the above program codes, the compiler only need to handle the registers R1 to R4 and does not need to take care physical address and data dependency in the memory storage 300 (i.e., physical address and data dependency are handled by the L1 managing unit of the memory controller 200. Therefore, the program codes are more concise as shown in Table 2-2, the program codes are easier to be generated by the compiler.

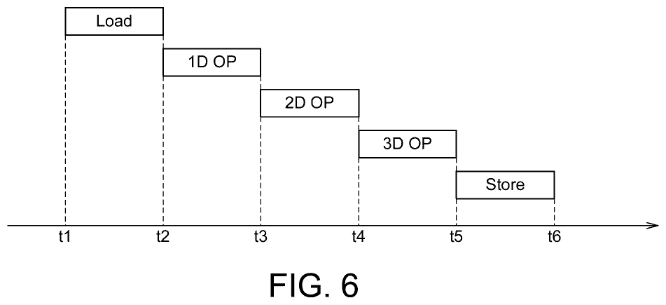

Efficiency of the pipelined operations of the computing engines 110 to 140 may be compared with a comparative example of FIG. 6, as will be described below.

FIG. 6 illustrates a schematic diagram showing non-pipelined operations of a comparative example. In the non-pipelined manner, a subsequent operation has to wait the completion of the previous operation. Such as, the load operation is completed at time point t2, and computing system 2000 checks load operation is done. Then, 1D operation starts at time point t2 and completes at time point t3. As 1D operation is checked as being completed, 2D operation starts at time point t3. Likewise, 3D operation starts at time point t4 when 2D operation is completed, and store operation starts at time point t5 when 3D operation is completed. The above non-pipelined operations may be performed according to a set of program codes listed as Table 3.

TABLE 3

LOAD dest = 0x00
. . .
LOAD dest = 0x09
1D-OP src = 0x00, dest = 0x10
. . .
1D-OP src = 0x09, dest = 0x19
2D-OP src = 0x10, dest = 0x20
. . .
2D-OP src = 0x19, dest = 0x29
3D-OP src = 0x20, dest = 0x30
. . .
3D-OP src = 0x29, dest = 0x39
. . .
STORE src = 0x30
. . .
STORE src = 0x30

As shown in Table 3, the comparative example does not utilize registers of the managing table, hence the compiler needs to handle physical address and data dependency in the memory storage 300. Such as, for the 1D operation the compiler has to set the source address as “0x00” and the destination address as “0x10”, then change the source address as “0x09” and the destination address as “0x19”, etc. Therefore, the program codes as Table 3 are more complex and difficult to be generated by the compiler, compared with the example of Table 2-2 of the present disclosure.

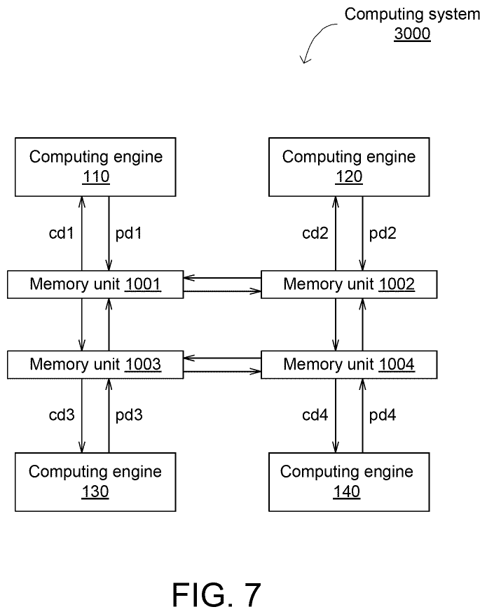

FIG. 7 illustrates a block diagram of a computing system 3000 of another comparative example. Referring to FIG. 7, the computing system 3000 utilizes four dedicated memory units 1001 to 1004. The memory unit 1001 is dedicated for the consumed data cd1 and produced data pd1 of the computing engine 110. Furthermore, the memory unit 1002 is dedicated for the consumed data cd2 and produced data pd2 of the computing engine 120. Likewise, the memory units 1003 and 1004 are dedicated for computing engines 130 and 140.

The memory units 1001 to 1004 with exclusive memory spaces, which are dedicated for computing engines 110 to 140, may require more complex management and synchronization to ensure proper data allocation/deallocation. In contrast, the shared memory mechanism utilized by the memory device 1000 of the computing system 2000 of FIG. 1 has advantages over the dedicated memory mechanism of FIG. 7. Such as, the shared memory mechanism of FIG. 1 may achieve enhanced communication and coordination between computing engines 110 to 140, where computing engines 110 to 140 can directly access and share data in the unified memory space of the memory device 1000.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A computing system comprising a memory device and a plurality of computing engines,
the memory device, comprising:
a memory storage; and
a memory controller, used to utilize a plurality of registers to manage a plurality of memory spaces in the memory storage;
wherein the plurality of computing engines are used to execute a plurality of computations, read a plurality of consumed data from the memory storage for processing, and write the processed data as produced data to the memory storage;
wherein the memory controller is configured to utilize a managing table to record an identifier, a base address, a bound address, a delete size, a head pointer, a tail pointer, and two indicators of each of the registers.

2. The computing system of claim 1, wherein a corresponding one of the registers has a reserved memory space in the memory storage, the reserved memory space is defined by the base address and the bound address.

3. The computing system of claim 1, wherein the corresponding one of the registers has an available data with a start and an end, the start is pointed by the head pointer, and the end is pointed by the tail pointer, the head pointer and the tail pointer are located between the base address and the bound address.

4. The computing system of claim 3, wherein in a read operation for the corresponding one of the registers to read the consumed data, a read pointer is located between the head pointer and the tail pointer associated with the available data.

5. The computing system of claim 4, wherein the read operation for the corresponding one of the registers is performed based on a predefined read-ordering for the computing engines.

6. The computing system of claim 4, wherein when the read operation has a read size greater than a size of the available data, the read operation is stalled.

7. The computing system of claim 1, wherein the corresponding one of the registers has a first available data with an end pointed by the tail pointer and a second available data with a start pointed by the head pointer, and an available memory space between the first available data and the second available data is defined by the tail pointer and the head pointer.

8. The computing system of claim 7, wherein in a write operation for the corresponding one of the registers to write the produced data, a write pointer is located within the available memory space.

9. The computing system of claim 8, wherein the write operation for the corresponding one of the registers is performed based on a predefined write-ordering for the computing engines.

10. The computing system of claim 8, wherein when the write operation has a write size greater than a size of the available memory space, the write operation is stalled.

11. The computing system of claim 1, wherein the memory controller has a compiler for maintaining the base address, the bound address and the delete size in a software level.

12. The computing system of claim 1, wherein the indicators include a “SEND busy” indicator and a “RECV busy” indicator, and the memory controller has a L1 managing unit for controlling the head pointer, the tail pointer, the “SEND busy” indicator and the “RECV busy” indicator in a hardware level.

13. The computing system of claim 12, wherein only one write operation associated with the “RECV busy” indicator or only one read operation associated with the “SEND busy” indicator are executed at the same time for each of the registers.

14. A memory managing method for a computing system, wherein the computing system includes a memory device and a plurality of computing engines, the memory managing method comprising:
storing a plurality of consumed data by a memory storage of the memory device;
utilizing a plurality of registers to manage a plurality of memory spaces in the memory storage, by a memory controller of the memory device; and
executing a plurality of computations, reading the consumed data from the memory storage for processing, and writing the processed data as produced data to the memory storage, by the computing engines;
wherein a managing table is utilized by the memory controller to record an identifier, a base address, a bound address, a delete size, a head pointer, a tail pointer, and two indicators of each of the registers.

15. The memory managing method of claim 14, wherein a corresponding one of the registers has a reserved memory space in the memory storage, the reserved memory space is defined by the base address and the bound address.

16. The memory managing method of claim 14, wherein the corresponding one of the registers has an available data with a start and an end, the start is pointed by the head pointer, and the end is pointed by the tail pointer, the head pointer and the tail pointer are located between the base address and the bound address.

17. The memory managing method of claim 16, further comprising:
in a read operation for the corresponding one of the registers to read the consumed data, locating a read pointer between the head pointer and the tail pointer associated with the available data.

18. The memory managing method of claim 14, wherein the corresponding one of the registers has a first available data with an end pointed by the tail pointer and a second available data with a start pointed by the head pointer, and an available memory space between the first available data and the second available data is defined by the tail pointer and the head pointer.

19. The memory managing method of claim 18, further comprising:
in a write operation for the corresponding one of the registers to write the produced data, locating a write pointer is within the available memory space.

20. The memory managing method of claim 14, wherein the indicators include a “SEND busy” indicator and a “RECV busy” indicator, and the memory managing method further comprising:
controlling the head pointer, the tail pointer, the “SEND busy” indicator and the “RECV busy” indicator in a hardware level, by a L1 managing unit of the memory controller;
wherein only one write operation associated with the “RECV busy” indicator or only one read operation associated with the “SEND busy” indicator is executed at the same time for each of the registers.
